(19) United States
(12) Patent Application Publication
(10) Pub. No.: US 2016/0134911 A1
(43) Pub. Date: May 12, 2016

(54) SYSTEM AND METHOD FOR SYNCHRONIZING PUBLIC EVENT MUSIC BROADCAST TO MOBILE PHONES

(71) Applicant: JÉRÔME TÉTREAULT, Quebec (CA)

(72) Inventor: JÉRÔME TÉTREAULT, Quebec (CA)

(21) Appl. No.: 14/696,870

(22) Filed: Apr. 27, 2015

Related U.S. Application Data
(60) Provisional application No. 62/078,376, filed on Nov. 11, 2014.

(51) Int. Cl. H04N 21/242; H04N 21/81

(52) U.S. Cl. CPC H04N 21/242; H04N 21/812

(57) ABSTRACT

A system and method for providing audio/video program files associated with a public event to mobile computing devices, including smartphones, for playback during the public event, wherein storing the audio/video program files before the public event mitigates the timing and scalability issues inherent in the present state of the art.

### CROSS REFERENCE TO RELATED APPLICATION

The present application is related to Provisional patent application entitled “System to broadcast pyromusical show's music to mobile phones,” filed 11 Nov. 2014 and assigned filing No. 62/078,376, incorporated herein by reference in its entirety.

### FIELD OF THE INVENTION

The present invention relates to a system and method for synchronizing music played for a public event with the music played on mobile phones.

### BACKGROUND OF THE INVENTION

Pyromusical shows are fireworks shows synchronized to a music track. The choreography of the pyrotechnical performance is synchronized to musical features of the sound track in order to provide an optimal artistic performance. The music is traditionally broadcast over loud speakers or FM radio stations, allowing viewers a synchronized listening and viewing experience.

Currently available technologies for broadcasting music over data networks, such as music streaming, do not allow for an appropriate synchronization of the sound track with the show. These technologies typically introduce a delay going for a few seconds to a few tens of seconds. Furthermore these technologies require a large amount of bandwidth to provide sound quality and are therefore unsuitable for large live audiences.

What is needed is a system and method that provides for the broadcasting of synchronized performance music to viewers and audience members over the public wireless network via mobile phones.

### BRIEF SUMMARY OF THE INVENTION

In one aspect of the present invention, a system suitable for providing, to a plurality of mobile communication devices, a music program in synchronization with actions executed in a public event, comprises: a central computer including a database server, a file server and a public event server application, the central computer storing a music/video program file associated with the public event, the music/video program file including a predetermined selection of music files; a plurality of music synchronization mobile apps, each music synchronization mobile app resident in a respective mobile communication device, each music synchronization mobile app further in communication with the public event server application; and a command console for providing a music program start signal to the public event server application.

In another aspect of the present invention, a method for providing, to a mobile communication device used by an attendee of a public event, music synchronized to actions executed in the public event, the method comprising: creating a music/video program file related to the public event, the music/video program file including at least one audio file; downloading the music/video program file to the mobile communication device in advance of the public event; transmitting a start signal to the mobile communication device in advance of the public event; and initiating playback of the music/video program file in the mobile communication device in response to receipt of the start signal.

The additional features and advantage of the disclosed invention is set forth in the detailed description which follows, and will be apparent to those skilled in the art from the description or recognized by practicing the invention as described, together with the claims and appended drawings.

### BRIEF DESCRIPTIONS OF THE DRAWINGS

The foregoing aspects, uses, and advantages of the present invention will be more fully appreciated as the same becomes better understood from the following detailed description of the present invention when viewed in conjunction with the accompanying figures, in which:

FIG. 1 is a diagrammatical illustration of a music synchronization system with a command console, a mobile communication device, and a central computer, in accordance with the present invention;

FIG. 2 is a flow diagram illustrating the process for preparing a music/video program file for storage in a database and file server in the central computer of FIG. 1; and

FIG. 3 is a flow diagram illustrating the process for retrieving the music/video program file of FIG. 2 and utilizing the retrieved music/video program file in the mobile communication device of FIG. 1.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention. The present invention provides a system and method for the synchronized broadcasting of performance music to viewers and audience members over the public wireless network via mobile phones.

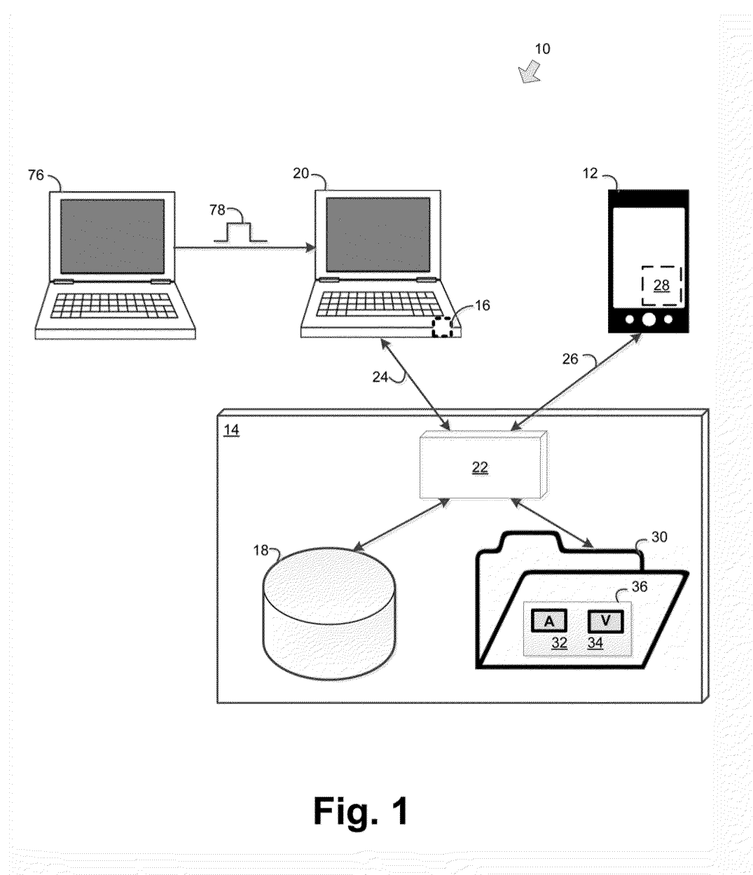

As shown in FIG. 1, a music synchronization system 10 comprises a mobile computing platform such as, for example, a mobile communication device 12 (e.g., a Smartphone), and a central computer 14. The central computer 14 is controlled by an official of a public event, such as a pyromusical performance, via a command console 20 located at the public event. The central computer 14 includes a database server 18, a file server 30 and a public event server application 22.

The public event server application 22 in the central computer 14 communicates with the command console 20 over a first communication link 24, and with a music synchronization mobile app 28, resident in the mobile communication device 12, over a second communication link 26. The music synchronization system 10 provides for synchronization between: (i) a music file 32 and an optional video file 34 played for a user via the mobile communication device 12, and (ii) the execution of the public event presentation related to the music file 32 and optional video file 34. This synchronization requires that an event attendee use the music synchronization mobile app 28 to download and store the music/video program file 36, which is composed of music file 32 and optional video file 34, on his or her mobile communication device 12 in advance of the public event scheduled start time.

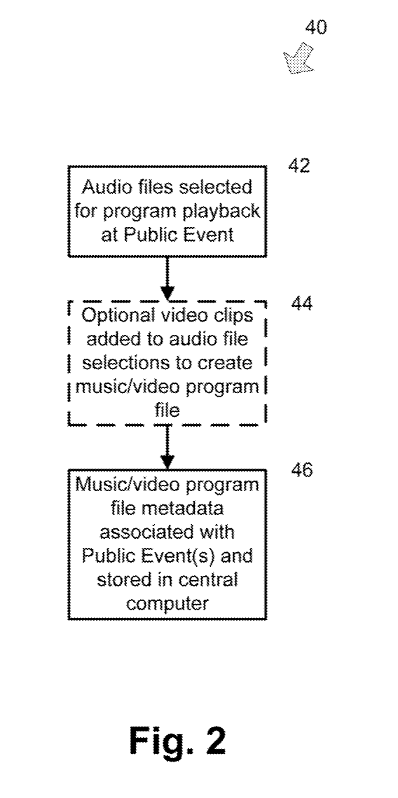

At step 42, shown in the flow diagram 40 in FIG. 2, a predetermined selection of audio files are combine to create a music file 32 for a particular public event, such as the pyromusical performance, and stored in the file server 30.

Public event programs are not limited to music file 32, and can include sponsor videos files 34 that can be played before and after each public event performance. The public event program may also include one or more public event sponsor video advertisements, to be played during the music part of the show, with the predetermined selection of music files. The public event server application 22 thus may add one or more optional video clips 34 to the primary music score 32, at step 44, to create the completed music/video program file 36. The music/video program file 36 is associated with meta-data stored in the database 18, at step 46. This meta-data is related to a selected public event, and includes information such as, for example, the public event date, scheduled start time, location, title, description and web links. The music/video program file 36 created for a specific public event may be retrieved from the file server 30 as needed by requesting the associated public event files associated with a unique public event identification code from the file server 30, where the public event identification code is unique to the specific public event.

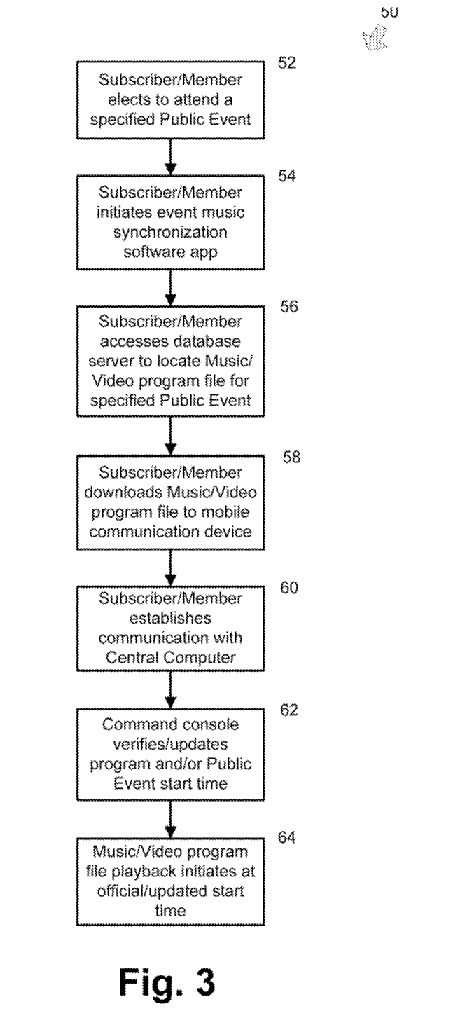

As shown in a flow diagram 50, in FIG. 3, the disclosed method is initiated when a subscriber, or member, having access to the event music synchronization mobile app 28, decides to attend a particular public event, at step 52. Prior to the start of the public event, the subscriber/member may initiate the event music synchronization mobile app 28 on the mobile communication device 12, at step 54. Using the event music synchronization mobile app 28, the subscriber accesses the information retrieved from the database server 18, at step 56, to find the selected public event and the date(s) of performance, and locate the music/video program file 36 associated with the public event performance of interest to the subscriber. The music/video program file 36 is then downloaded to the mobile communication device 12 from the file server 30, at step 58.

At the public performance venue, the subscriber/member may communicate with the central computer 14 over the second communication link 26. This action enables the subscriber/member to have availability to the latest information for a start time for the playback of the music 32 file over the mobile communication device 12, at step 60. During the public event performance, the central computer 14 sends the music track start time in universal time format along with the unique public event identification code to the mobile communication device 12 over the second communication link 26. Note that, if the received public event identification code is the incorrect code for the local performance, the music/video program file 36 stored in the mobile communication device 12 may not play at the anticipated start time. This novel approach allows for essentially perfect synchronization of (i) the music 32 and video 34 program files heard on the mobile communication device 12 with (ii) the actions occurring in the public event performance. By sending the music track start time in universal time format, as opposed to sending the current playback point in the music track, the proposed approach eliminates the effect of network latency in the communication link 26 assuming that all internal devices clocks are synchronized.

In addition, this method of sending timing signals to synchronize playback of the music/video program file 36 by the mobile communication devices 12 enables scalability to larger audiences by reducing to a strict minimum the data bandwidth that is required. This bandwidth reduction is accomplished by the transmission of only timing signals to the attendees' mobile communication devices 12 at the time of the live public event. Transmission of the predetermined selection of music files and the optional video(s) is not required as the music/video program file 36 has been stored in the attendees' mobile communication devices 12 prior to the start of the public performance, thus spreading the associated network and server load over several days prior to the event. Since the network load associated with sending the timing data is extremely small, this approach allows scalability to a near limitless audience size.

Before, and perhaps during, the public event performance, the command console 20 may update the program by providing to the central computer 14: (i) new times, (ii) new music sequences, (iii) new or replacement music files, and/or (iv) new or replacement video clips, in the playback of the music/video program file 36, at step 62. Whether or not there have been any changes to the music/video program file itself, playback of the music/video program file is initiated in the attendees' mobile communication devices 12 at the correct, “official,” or updated start time, at step 64. It should be understood that the disclosed method is applicable to many other types of public events, such as an aerial performance show, that utilize a predetermined music track associated with a live visual performance, and are subject to a changeable schedule.

As can be appreciated, the actual signal issued to start a pyromusical performance, for example, may not occur at a fixed time or at a preprogrammed time. Such performances rely on an anticipated start time which can be delayed due to wind conditions, or are set to start at a specific point in a sports game or other live performance. Such decisions are left to an event official in order to ensure safety and other considerations. Once the event official determines the timing of the start of the display, the start time is usually entered into the command console 20 for transmittal to the attendees' mobile communication devices 12. This is typically done a few minutes before the show. The music synchronization system 10 allows for changing the start time at any moment before, and during, the performance. The start time entered into the command console 20 is sent to the public event server application 22 along with the unique public event identification code associated with the pyrotechnical show selected by the attendee. The updated start time is stored in the database server 18.

The primary feature of the present invention is the custom-built music synchronization mobile app 28 on the mobile communication device 12 which downloads audio/video program files 36 from the file server 30 as described above. Once downloaded, the music/video program file 36 is stored in the memory 28 of the mobile communication device 12 in such a manner that the music/video program files 36 cannot be played, seen, or otherwise accessed by the user of the mobile communication device 12 before the start of the public event.

After the public event performance has ended, and the music/video program file 36 is no longer required, selected files can be deleted from the mobile communication device 12 memory in order to free memory space. The decision to delete a particular audio/video program file 36, can be based on an expiry date stored alongside the file, or can be determined by sending a request to the public event server application 22 asking which file(s) should be deleted from the mobile communication device 12.

The music synchronization mobile app 28 can, typically, be associated and branded with a public event, a show producer or can be a generic event software application. The music synchronization mobile app 28 sends a code identifying itself along each request sent to the server application 22 in order to filter only content relevant to itself to be downloaded and played back. The music synchronization mobile app 28 can provide additional functionality associated with a show or an event, such as an event schedule, a map of venues, logos of sponsors, special offers, or a voting option in the case of a fireworks contest where the audience is asked to rate each performance. The present invention does not limit the type of functionalities that can be added with the event music synchronization mobile app 28.

If the event music synchronization mobile app 28 is associated with multiple shows or public events that can run concurrently or over a large geographic area, such as Independence Day fireworks displays in various geographic locations, the music synchronization mobile app 28 serves to synchronize all local Independence Day fireworks performances. The geographic location (e.g., latitude and longitude) of a particular mobile communication device 12 can be used to restrict to the particular mobile communication device 12 the downloading from the file server 30, and playing back, the music/video program file 36 for nearby events only. This allows for limiting the bandwidth utilization of the music synchronization mobile app 28 by not downloading unneeded files.

The music synchronization mobile app 28 may also be programmed to check for new music files on the database server 18 on a periodic basis, for instance every day or every few hours. Once new content is identified, it can either be downloaded immediately to the device or the music synchronization mobile app 28 may decide to delay download until the device is connected to a Wi-Fi network. This allows for reducing mobile data charges for the end user.

Downloading music and video files ahead of time is a major benefit of this approach as it allows for much larger audiences to be served while not overloading the local wireless network serving the communication link 26 or the central computer 14. This also permits ideal synchronization as it eliminates the need to buffer and delay sound before sending it to the speaker of the mobile communication device 12. The music synchronization mobile app 28 will not allow playing the music/video program file 36 if the associated pyro musical show, or other public event, is not actually occurring.

An alternative mean of synchronizing the show is for the control computer 20 to receive and decode a timecode signal 78 from a public event production desk 76, or to receive a pulse from an automated fireworks firing computer (not shown). These methods remove the requirements to enter the precise show starting time and instead allow automated synchronization with the public event production desk 76.

The user can start the music on his or her mobile communication device 12 by either selecting a “play” option, or the music synchronization mobile app 28 can be programmed to automatically check and start the music playback. The music synchronization mobile app 28 sends a request to the server application 22 and receives in return the unique public event identification code and the latest, or updated, start time of the show. Based upon receiving the correct unique public event identification code and the latest start time, the mobile communication device 12 automatically starts the music at the correct, or updated, start time in order to ensure synchronization. The mobile communication devices 12 may send a new request every few seconds in a process known as “polling” in order to ensure that the start time of the event has not changed.

If a time change has occurred, the music synchronization mobile app 28 automatically adjusts the playback point in order to resynchronize the music with the live public event performance. The timing information requests sent by the mobile communication device 12 over communication link 26 may utilize a light weight connectionless datagram protocol such as User Datagram Protocol (UDP). While not limiting the design options and claims of the present patent application, this design does typically allow much greater scalability to several hundreds of thousands of devices while using limited server computational resources.

Synchronization relies on the basis that all mobile telecommunication devices 12, the central computer 14 and the command console 20 have synchronized clocks. This problem is already solved in the industry by the Network Time Protocol (NTP) which allows for synchronizing a device clock with a centralized time server.

It is to be understood that the description herein is only exemplary of the invention, and is intended to provide an overview for the understanding of the nature and character of the disclosed music synchronization system and method. The accompanying drawings are included to provide a further understanding of various features and embodiments of the method and devices of the invention which, together with their description serve to explain the principles and operation of the invention.

What is claimed is:

1. A system suitable for providing, to a plurality of mobile communication devices, a music program in synchronization with actions executed in a public event, said system comprising:
a central computer including a public event server application, a database to store meta-data related to the public event, and a file server storing music/video files;
a plurality of music synchronization mobile apps, each said music synchronization mobile app resident in a respective mobile communication device, each said music synchronization mobile app further in communication with said public event server application; and
a command console for providing a music program start signal to said public event server application.

2. The system of claim 1 wherein each said music synchronization mobile app responds to said public event server application by initiating playback of said music/video program file in synchronization with said music program start time signal and a unique public event identification code.

3. The system of claim 1 wherein said music/video program file comprises at least one public event sponsor video advertisement.

4. The system of claim 1 wherein said music synchronization mobile app periodically queries said public event server application to determine a need for downloading additional music files or additional video files, said need based on at least one of: (i) a current date, (ii) a scheduled date for a public event performance, (iii) a location for said public event performance, and (iv) a geographic location obtained for the mobile communication device.

5. The system of claim 1 wherein said database server comprises metadata associated with at least one of: (i) a unique public event identification code, (ii) a show producer, (iii) a pyrotechnical operator, (iv) a music file link, (v) a public event producer, (vi) a video advertisement file link, (vii) a title and description, (viii) a scheduled start date and time, and (ix) a geographical location.

6. The system of claim 1 further comprising a command console in communication with said central computer, wherein said command console is operated by an official of the public event to transmit said music program start time along with public event unique identification code to said central computer.

7. The system of claim 1 wherein said music synchronization mobile app functions to periodically query said database server to: (i) determine a valid public event start time, and (ii) adjust said music/video program playback according to a clock synchronized to a central clock source.

8. The system of claim 1 further comprising a public event production desk, wherein said command console functions to send a start signal to said central computer in response to receiving a timecode signal from said public event production desk.

9. The system of claim 1 wherein said music/video program file is executed only upon receipt of said start time from public event server program running on central computer.

10. The system of claim 1 wherein said music/video program file comprises an expiry date.

11. A method of providing, to a mobile communication device used by an attendee of a public event, music synchronized to actions executed in the public event, said method comprising the steps of:
creating a music/video program file related to the public event, said music/video program file including at least one audio file;
downloading said music/video program file to the mobile communication device in advance of the public event;
transmitting a start time and a unique public event identification code to the mobile communication device, said unique public event identification code associated with the public event; and
initiating playback of said music/video program file in the mobile communication device at said start time.

12. The method of claim 11 further comprising the step of revising said start time in response to a change in performance schedule of the public event.

13. The method of claim 11 further comprising the step of periodically querying said public event server application to: (i) determine a valid public event start time and unique public event identification code, and (ii) to adjust music playback according to a clock utilizing a time synchronization protocol to synchronize to a central clock source.

14. The method of claim 11 wherein said step of transmitting a start time is executed in advance of the public event.

15. The method of claim 11 wherein said step of transmitting a start time is executed during the public event.

16. The method of claim 11 wherein a command console located at the public event functions to send said start signal in response to receiving a timecode signal from a public event production desk.

17. The method of claim 11 wherein said step of initiating playback of said music/video program file in the mobile communication device is executed in response to receipt of said unique public event identification code.
